(19) United States
(12) Patent Application Publication
(10) Pub. No.: US 2012/0235880 A1
(43) Pub. Date: Sep. 20, 2012

(54) ULTRAHIGH-FREQUENCY PACKAGE MODULE

(75) Inventors: Joon-Il KIM, Seoul (KR); Shin-Hee CHO, Suwon-si (KR); Young-Min LEE, Yongin-si (KR); Jae-Hyuck LEE, Anyang-si (KR); Kyu-Sub KWAK, Suwon-si (KR); Sung-Ku YEO, Suwon-si (KR)

(73) Assignee: Samsung Electronics Co., Ltd.

(21) Appl. No.: 13/420,152

(22) Filed: Mar. 14, 2012

(30) Foreign Application Priority Data
Mar. 14, 2011 (KR) 10-2011-0022586

(51) Int. Cl. H01Q 1/24

(52) U.S. Cl. 343/884

(57) ABSTRACT

An ultrahigh-frequency package module is provided, including a first substrate having a plurality of power lines and a plurality of signal lines, and one or more second substrates provided on one surface of the first substrate and each being provided with at least one antenna. The second substrates are independently arranged one by one in a grid pattern along one surface of the first substrate.

### PRIORITY

This application claims priority to an application entitled “Ultrahigh-Frequency Package Module” filed in the Korean Industrial Property Office on Mar. 14, 2011, and assigned Ser. No. 10-2011-0022586, the contents of which are incorporated herein by reference.

### BACKGROUND OF THE INVENTION

1. Field of the Invention

The present invention relates generally to an ultrahigh-frequency package module, and more particularly, to an ultrahigh-frequency package module in which second substrates each having a single antenna are arranged in a grid pattern.

2. Description of the Related Art

Ultrahigh-frequency integrated circuits are generally used in transmitting/receiving units for various wireless communication devices such as portable, military, and satellite communication devices. Since such an ultrahigh-frequency circuit is manufactured through a semiconductor process in an unpackaged bare chip form, the circuit requires a package module.

As illustrated in FIG. 1, a package module 1 employs a high-k dielectric substrate 2 including an ultrahigh-frequency signal line (not shown), and a plurality of antennas 2a that are arranged and provided on a surface of and between inner layers of the high-k dielectric substrate 2. In order to form such a structure, the antennas 2a are stacked in the same substrate and are formed on a top surface of the substrate 2.

A Radio Frequency Integrated Circuit (RFIC) 3 electrically connected to the antennas 2a are provided in the high-k dielectric substrate 2.

In the conventional ultrahigh-frequency package module, since a plurality of antennas are arranged together on one substrate, an operation error, a signal delay, and distortion may be generated due to interference between the antennas and signal lines. Also, product miniaturization is difficult due to the size increase of a substrate having a plurality of antennas. Furthermore, product manufacturing costs increase, and the characteristics of antennas and ultrahigh-frequency signal lines deteriorate.

In addition, since high-k dielectric and low-k dielectric substrates are stacked and arranged in a conventional ultrahigh-frequency package module, the diameters of via holes formed in a high-k dielectric substrate are less than approximately 0.1 mm, while the diameters of via holes formed in a low-k dielectric substrate are approximately 0.1 mm. Thus, when the high-k dielectric and low-k dielectric substrates are stacked and used, the sizes of via holes are limited, causing degradation in the integrities of the substrates.

Thus, it is necessary to arrange antennas independently on a substrate in a grid pattern to prevent interference between antennas and signal lines, which may be caused by the antennas provided in one substrate, and to prevent product operation error, a signal delay, and distortion.

### SUMMARY OF THE INVENTION

Accordingly, the present invention has been made to solve the above-mentioned problems occurring in the prior art, and an aspect of the present invention provides an ultrahigh-frequency package module in which a plurality of second substrates each having one antenna are independently arranged on a first substrate in a grid pattern to prevent interference between antennas and signal lines, which have been generated when a plurality of antennas are conventionally provided in one substrate, and hence to prevent a product operation error, a signal delay, and distortion.

Another aspect of the present invention provides an ultrahigh-frequency package module in which a plurality of second substrates each having one antenna are independently arranged on a first substrate in a grid pattern such that the sizes of the second substrates are reduced, enabling product miniaturization, a reduction in product manufacturing costs, and an enhancement of the characteristics of antennas and signal lines.

A further aspect of the present invention provides an ultrahigh-frequency package module in which a plurality of second substrates each having one antenna are independently arranged on a first substrate in a grid pattern such that the sizes of via holes are not limited due to stacking of substrates, thereby increasing the integrity of the substrates and enhancing the function of a product.

In accordance with the present invention, there is provided an ultrahigh-frequency package module, including a first substrate having a plurality of power lines and a plurality of signal lines, and one or more second substrates provided on one surface of the first substrate and each having an antenna, wherein each of the second substrates is provided with at least one antenna, and is arranged independently one by one in a grid pattern along the one surface of the first substrate.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a conventional ultrahigh-frequency package module;

FIG. 2 illustrates an ultrahigh-frequency package module according to the present invention; and

FIG. 3 illustrates a second substrate of an ultrahigh-frequency package module according to the present invention.

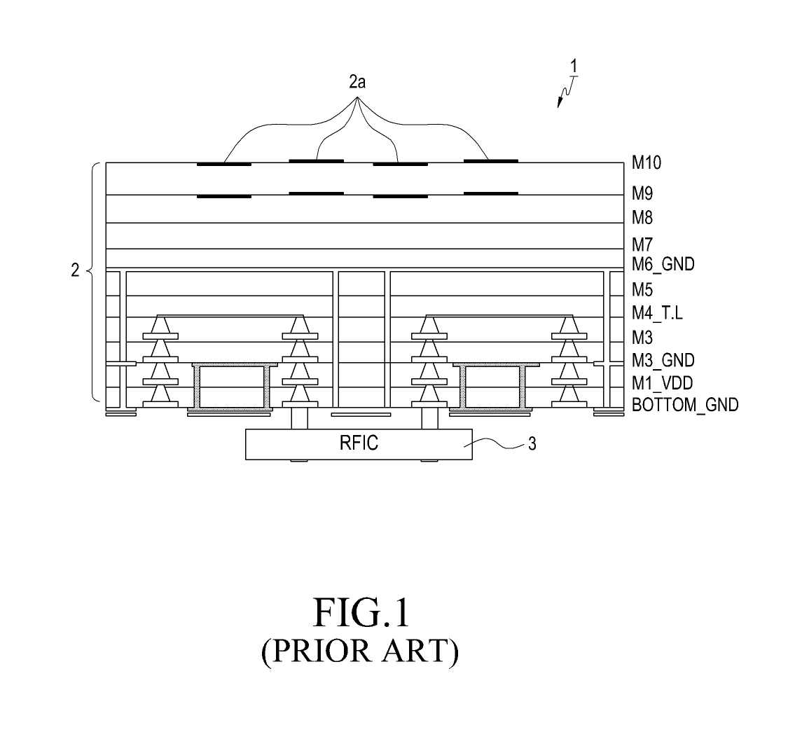

### DETAILED DESCRIPTION OF EMBODIMENTS OF THE PRESENT INVENTION

Hereinafter, embodiments of the present invention will be described in detail with reference to the accompanying drawings. The description of the embodiments and the illustrations herein are made only to explain the embodiments of the present invention, and various modifications could have been be made to replace them as of the time of the filing of the subject application. Further, a detailed description of known functions and configurations incorporated herein will be omitted for the sake of clarity and conciseness.

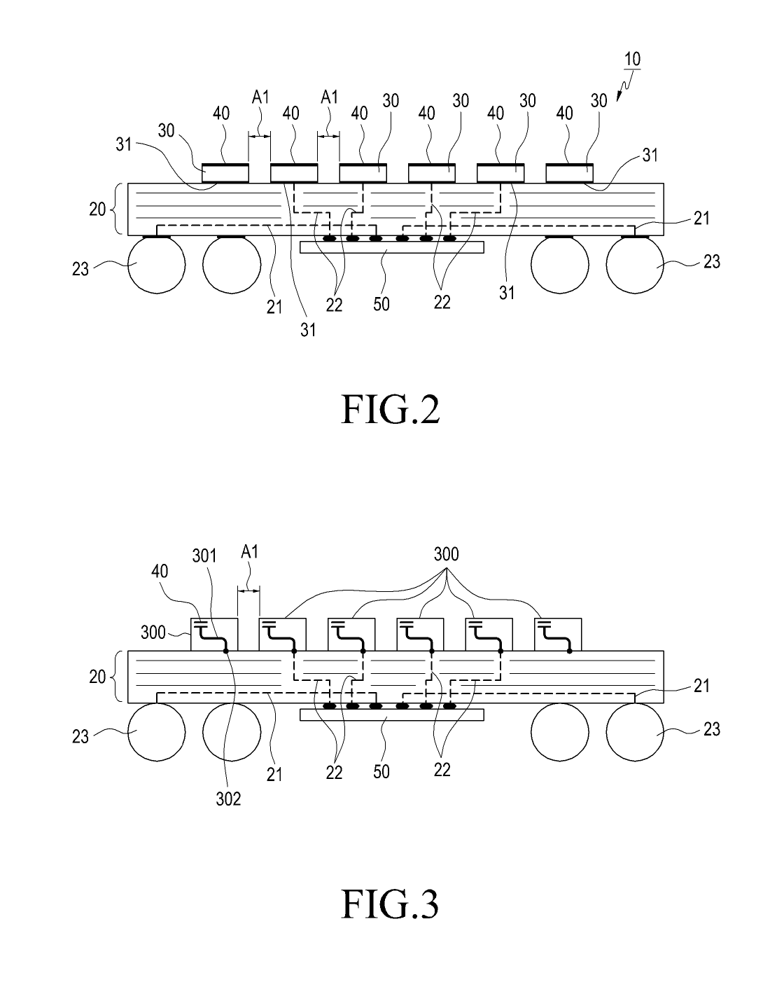

As illustrated in FIG. 2, an ultrahigh-frequency package module 10 includes a first substrate having a plurality of power lines 21 and a plurality of signal lines 22, and one or more second substrates 30. The first substrate 20 is provided under the second substrates 30 to connect the signal lines 22 to antennas 40 which will be described below. Each second substrate 30 includes an antenna 40 provided on one surface of the first substrate 20 to be electrically connected to the signal lines 22 of the first substrate 20.

As illustrated in FIG. 2, each second substrate 30 includes at least one antenna 40, and the second substrates 30 each having one antenna 40 are arranged independently one by one by an interval A1 in a grid pattern along one surface of the first substrate 20.

The first substrate 20 is made of a low-k dielectric material and the second substrates 30 are made of a high-k dielectric material, where the low-k dielectric material of the first substrate 20 has a relative permittivity (∈r) of 2 to 5, and the high-k dielectric material of the second substrates 30 has a relative permittivity (∈r) of 4 to 10.

A difference between the relative permittivity of the first substrate 20 and the second substrates 30 ranges from minimum 100% to maximum 400%.

As illustrated in FIG. 2, an RFIC 50 is provided in the first substrate 20 to be electrically connected to the antennas 40, and a plurality of power balls 23 are provided in the first substrate 20 to be electrically connected to the RFIC 50.

The antennas 40 are provided in the second substrates 30 through one of flipchip bonding, wire bonding, and paste soldering.

The RFIC 50 is provided in the first substrate 20 through one of flipchip bonding, wire bonding, and paste soldering.

As illustrated in FIG. 2, one antenna 40 is provided on one surface of each second substrate 30, and a connector 31 is provided on a bottom surface of each second substrate 30 to be electrically connected to the signal line 22.

The second substrate 30 may be made of one of ceramics, a polymer, ferrite, and carbon, but may also be made of any material other than ceramics, a polymer, ferrite, and carbon (for example, a material having a negative permittivity or permeability).

The electrodes of the antennas 40 may be made of one of Copper (Cu), Silver (Ag), Gold (Au), Aluminum (Al), and Stainless steel (STS), as well as other materials such as Nickel (Ni).

The ultrahigh-frequency package module 10 may be applied to a communication module (not shown) or a communication system (not shown) which utilizes a package module.

The antenna 40 includes an antenna element, an antenna array, and an antenna part.

FIG. 3 illustrates a second substrate 300 according to the present invention. As illustrated in FIG. 3, one antenna 40 is provided in each second substrate 300 and an antenna signal line 301 is provided in the second substrate 300 to be electrically connected to the antenna 40 and to electrically connect the antenna 40 to a signal line 22 of the first substrate 20.

An antenna connecting terminal 302 is provided in the antenna signal line 22 to be electrically connected to a connector (not shown) provided in the signal line 22 of the first substrate 20.

The operation of the ultrahigh-frequency package module according to the present invention will be described in more detail with reference to FIGS. 2 and 3.

As illustrated in FIG. 2, the ultrahigh-frequency package module 10 includes a first substrate 20 having a plurality of power lines 21 and signal lines 22, and one or more second substrates 30.

One antenna 40 is provided in each second substrate 30, and the second substrates 30 each having one antenna 40 are independently arranged one by one by an interval A1 in a grid pattern along one surface of the first substrate 20.

The antennas 40 are provided in the second substrates 30 through one of flipchip bonding, wire bonding, and paste soldering.

The first substrate 20 is made of a low-k dielectric material and the second substrates 30 are made of a high-k dielectric material.

An RFIC 50 is provided in the first substrate 20, and a plurality of power balls 23 are provided in the first substrate 20 to be electrically connected to the RFIC 50.

The power lines 21 of the first substrate 20 are electrically connected to the plurality of power balls 23.

The RFIC 50 is electrically connected to the signal lines 22 of the first substrate 20.

The RFIC 50 is provided in the first substrate 20 through one of flipchip bonding, wire bonding, and paste soldering.

Then, as illustrated in FIG. 2, a connector 31 is provided on a bottom surface of the second substrate 30, and the connector 31 is electrically connected to the signal lines 22 of the first substrate 20.

As illustrated in FIG. 3, one antenna 40 is provided in each second substrate 300 and an antenna signal line 301 is provided in the second substrate 300 to be electrically connected to the antenna 40 and to electrically connect the antenna 40 to a signal line 22 of the first substrate 20.

An antenna connecting terminal 302 is provided in the antenna signal line 22 to be electrically connected to a connector (not shown) provided in the signal line 22 of the first substrate 20.

In this state, the second substrates 300 each having one antenna 40 are independently arranged one by one at an interval A1 in a grid pattern along one surface of the first substrate 20.

Then, the connectors (not shown) provided in the signal lines 22 of the first substrate 20 are electrically connected to the antenna connecting terminals 302 of the second substrates 30.

According to the present invention, since one or more second substrates 30 each having one antenna 40 are formed on one surface of the first substrate 20 at an interval A1 in a grid pattern, interference that has been generated between antennas and signal lines when a plurality of antennas are provided in a conventional substrate, is prevented. Accordingly, product operation error, a signal delay, and distortion are prevented. Furthermore, the sizes of the second substrates 20 are reduced, enabling product miniaturization and a reduction in product manufacturing costs.

Meanwhile, the ultrahigh-frequency package module according to the present invention can be applied to a transmitting/receiving unit of a wireless system as a representative application. However, the ultrahigh-frequency package module is not necessarily limited to a transmitting/receiving unit of a wireless system, but may be applied to various types of terminals equipped with a transmitting/receiving unit.

Examples of various types of terminals equipped with a transmitting/receiving unit may include all information communication devices, multimedia devices, and application devices including all mobile communication terminals that operate based on communication protocols corresponding to communication systems, MPEG Layer Audio 3 (MP3) players, Portable Multimedia Players (PMPs), navigation systems, gaming devices, laptop computers, advertizing panels, TVs, digital broadcasting players, personal digital assistants, and smart phones.

While the invention has been shown and described with reference to embodiments thereof, it will be understood by those skilled in the art that various changes in form and details may be made therein without departing from the spirit and scope of the invention as defined by the appended claims.

What is claimed is:

1. An ultrahigh-frequency package module, comprising:
a first substrate having a plurality of power lines and a plurality of signal lines; and
one or more second substrates provided on one surface of the first substrate,
wherein each of the one or more second substrates is provided with at least one antenna, and the one or more second substrates are independently arranged one by one in a grid pattern along the one surface of the first substrate.

2. The ultrahigh-frequency package module as claimed in claim 1, wherein the first substrate is made of a low-k dielectric material and the one or more second substrates are made of a high-k dielectric material.

3. The ultrahigh-frequency package module as claimed in claim 1, wherein the low-k dielectric material of the first substrate has a relative permittivity of 2 to 5, and the high-k dielectric material of the second substrates has a relative permittivity of 4 to 10.

4. The ultrahigh-frequency package module as claimed in claim 1, wherein a difference between the relative permittivity of the first substrate and the relative permittivity of the second substrates ranges from 100% to 400%.

5. The ultrahigh-frequency package module as claimed in claim 1, wherein a Radio Frequency Integrated Circuit (RFIC) electrically connected to the antenna is provided in the first substrate, and a plurality of signal balls and a plurality of power balls electrically connected to the RFIC are provided in the first substrate.

6. The ultrahigh-frequency package module as claimed in claim 5, wherein the RFIC is provided in the first substrate through one of flipchip bonding, wire bonding, and paste soldering.

7. The ultrahigh-frequency package module as claimed in claim 1, wherein the antenna is provided in the second substrates through one of flipchip bonding, wire bonding, and paste soldering.

8. The ultrahigh-frequency package module as claimed in claim 1, wherein one antenna is provided on one surface of each second substrate, and a connector electrically connected to a signal line of the first substrate is provided on a bottom surface of each of the one or more second substrates.

9. The ultrahigh-frequency package module as claimed in claim 1, wherein the one or more second substrates are made of one of ceramics, a polymer, ferrite, and carbon.

10. The ultrahigh-frequency package module as claimed in claim 1, wherein the antenna is made of one of copper, silver, gold, aluminum, and stainless steel.

11. The ultrahigh-frequency package module as claimed in claim 1, wherein each of the second substrates includes one antenna, and an antenna signal line electrically connected to the antenna and electrically connecting the antenna to a signal line of the first substrate.

12. The ultrahigh-frequency package module as claimed in claim 11, wherein an antenna connecting terminal electrically connected to a connector of the signal line of the first substrate is provided in the antenna signal line.

13. The ultrahigh-frequency package module as claimed in claim 1, wherein the ultrahigh-frequency package module is applicable to a communication module or a communication system that uses a package module.

14. The ultrahigh-frequency package module as claimed in claim 1, wherein the antenna includes an antenna element, an antenna array, and an antenna part.
